(19) United States
(12) Patent Application Publication
(10) Pub. No.: US 2008/0187897 A1
(43) Pub. Date: Aug. 7, 2008

(54) SYSTEM AND METHOD FOR PROVIDING SINGLE SOURCE WORK INSTRUCTIONS WITH USER SELECTABLE OUTPUT FORMAT

(76) Inventors: Steven E. Franzen, St. Charles, MO (US); Carl E. Bouffiou, Tacoma, WA (US); Robert J. Schreiber, St. Louis, MO (US); Joseph Anelle, St. Charles, MO (US); Jennifer C. Theisen, St. Charles, MO (US); Mark O. Fortney, St. Charles, MO (US); Jay S. Seddon, St. Charles, MO (US)

Correspondence Address: HARNESS, DICKEY & PIERCE, P.L.C., P.O. BOX 828, BLOOMFIELD HILLS, MI, 48303, US

(21) Appl. No.: 11/670,646

(22) Filed: Feb. 2, 2007

(51) Int. Cl. G09B 3/00

(52) U.S. Cl. 434/350

(57) ABSTRACT

A system and method that makes use of a software module for implementing a work instruction authoring tool having a user selectable output format. In one embodiment the software module is in communication with a single source library containing a plurality of different types of process data for enabling a plurality of different types of work instruction authoring tools to be executed. The software module provides a user selectable output field. This enables the user to select output information from the work authoring tool to be presented in a text window, as an annotation, or as an audio output. Enabling the user to select the output format of information being used to perform a work instruction significantly enhances the flexibility and ease of manipulating and working with various types of data and information while creating or modifying a work instruction.

### FIELD

The present disclosure relates to systems and methods for providing work instructions via a software product, and more particularly, to a system and method in which a user is able to select a desired work instruction and to have information pertaining to the selected work instruction presented in a user selectable output format.

### BACKGROUND

The statements in this section merely provide background information related to the present disclosure and may not constitute prior art.

In the pursuit of applying lean manufacturing principles to the various processes and tools used to manufacture various types of products, and particularly to manufacturing aircraft and aerospace related products, there is a need to analyze and integrate features of multiple software applications into a common, company wide application. However, simply integrating various features of multiple applications can result in less than optimum presentation of pertinent information or work instructions being provided to the user. Often information pertaining to a work instruction is provided in different formats when the user is using different work applications. Often, the formats may not be the specific type of format that best enables the user to understand and make use of a given work instruction authoring tool that the user is working with. Furthermore, the lack of a user selectable output feature may require the user to interpret output information in a less than optimum format. Alternatively, it may require the user to perform redundant work instruction authoring operations or lengthen the time needed to complete a specific task when using a given work instruction authoring tool.

When a user is making use of two or more different work instruction authoring software applications, typically separate databases are accessed by the work instruction authoring software tools. Efficiency would be enhanced if two or more work instruction authoring software tools could be configured to use a single work instruction authoring database.

Therefore, there exists a need to provide a system and method that enables a single application to be provided in which the user is able to select a desired operation from a work instruction authoring tool, and further to select a specific output format in which information is to provide to the user. Such capability would significantly enhance the usefulness of the information provided to the user by work instruction authoring tool, as well as potentially reduce redundant operations that might be required if information pertaining to a particular operation could not be provided to the user in an optimum output format. A need also exists for more efficiently using database information that is needed for two or more work instruction authoring software tools.

### SUMMARY

The present disclosure relates to a system and method in which a work authoring tool is provided that allows the user to select from one of a plurality of different output formats when viewing pertinent information pertaining to a selected work instruction.

In one implementation, a method is provided by which a user is able to select from one of plurality of different work instruction authoring tools, and in which each of the work instruction authoring tools are able to access a single source library of pertinent information. The method provides an output selection field in a work authoring application in which the user may select one of a plurality of different output formats in which information generated by the selected work instruction authoring tool may be presented to the user. Pertinent information resulting from the selected work instruction is provided to the user in accordance with the selected output format. This optimizes the ability of the user to work with the information while authoring or amending a work instruction.

In one specific implementation, the user is able to select an output format that comprises an audio output, an annotation of text pertaining to the work instruction, or a detailed text window in which text pertaining to the work instruction is displayed.

In another implementation, a graphical representation of information pertaining to a selected work instruction is presented for display in a display window.

In still another implementation, a work authoring tool enables the user to select a specific process type that pertains to a specific work operation or work process, as well as a sub process type that pertains to a specific sub-operation or sub-feature of the selected work operation or work process.

A software product in accordance with the present disclosure is also provided. The software product, in one implementation, includes a first field in which a user may specify at least one of a plurality of criterion to be used in implementing a work instruction via a work instruction authoring tool being implemented by the software product. A second field is provided in which the user may select one of a plurality of different work process types to be performed during a selected work instruction. A third field is provided in which the user may select one of a plurality of different output formats to be used in providing information to the user concerning the selected work instruction. A fourth field may be provided in which specific information concerning the selected work instruction is provided to the user in accordance with the selected output format.

The system and method thus enables the user to select one of a plurality of specific output formats that better enables the user to make use of the information being manipulated and/or processed with one or more work instruction authoring tools.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a block diagram showing an example of an integrated architecture in accordance with the present system;

FIG. 2 is an illustration of a prior art work instruction authoring application making use of a first process library;

FIG. 2A is an illustration of a prior art second work instruction authoring tool making use of a second process library;

FIG. 2B is an illustration of a prior art shop floor graphical user interface and its typical graphic work instruction viewer;

FIG. 3 is an illustration of another prior art work authoring application that allows both the textual content of the plan and the graphical content to be created in a single system, but does not include the capability to display the work instructions (from a process library) in an annotated format;

FIG. 4 is an illustration of one exemplary implementation of a software module in accordance with the present disclosure that enables a desired text output format to be selected therefrom, in this example an annotation;

FIG. 5 is an illustration of the software module of the present disclosure, but instead showing a text window output being displayed; and

FIG. 6 is an illustration of an exemplary, notational audio work instruction format provided by the system and method of the present disclosure.

### DETAILED DESCRIPTION

The following description is merely exemplary in nature and is not intended to limit the present disclosure, application, or uses.

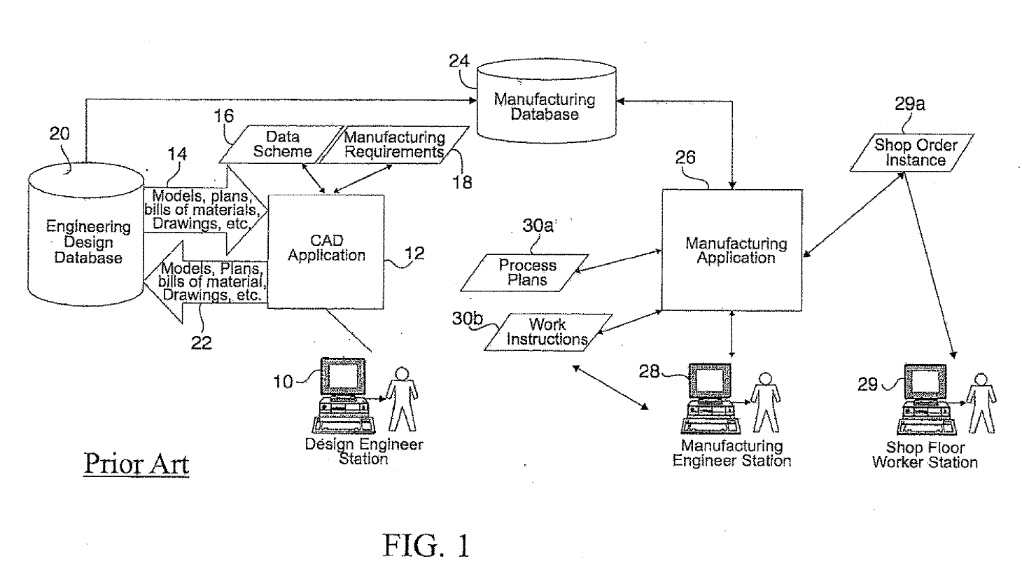

Referring to FIG. 1, there is shown a representative environment in which a system and method of the present disclosure may be employed. This environment involves a plurality of distinct work applications that are in communication with a common database. In this example, a design engineer station 10 makes use of a CAD application 12 to obtain various forms of information and/or data 14, 16, and 18 needed to perform an engineering design operation. Certain information, for example, models, plans, bills of material, drawings, etc., is denoted collectively by numeral 14, and may be obtained from an engineering design database 20. The CAD application 12 may output models, plans, bills of materials, drawings or other forms of information, as denoted by numeral 22, to the engineering design database 20. The engineering design database 20 is communication with a manufacturing database 24 and outputs engineering design information to the manufacturing database 24. The manufacturing database 24 is also in communication with a manufacturing application 26 that is being used by a user at a manufacturing engineer station 28. The manufacturing application 26 is used to generate process plans 30a and work instructions 30b. The manufacturing engineer station 28 may be used to create or amend work instructions via a work instruction authoring tool, and more typically via a plurality of work instruction authoring tools that may be accessed and used from the manufacturing engineer station 28. Typically such work authoring tools have heretofore needed to access different databases of information, which lends to increase the complexity and time required to produce or process work instructions.

A typical “process flow” scenario for the system of FIG. 1 would be as follows. Work product data is created to define the physical product and product requirements. A Product data structure (naming and organization) is initiated in the engineering design database 20. The product structure (part or assembly) is then sent to the CAD Application 12 to be defined using three dimensional model based methodology. When the part and/or assembly are defined, the product definition is saved back to the engineering design database 20. The product data is then made available via two way communication with the manufacturing database 24.

The plan author opens the manufacturing application 26 and accesses the fabrication, assembly or installation plan from the manufacturing database 24. The plan author uses the manufacturing application 26 to add content to the process plan(s) 30A including work Instructions 30b. This is when the product data gets associated to the process definition and where the formatting of the work instruction is defined by the author. The process plan with work instruction content is then stored in the manufacturing database 24.

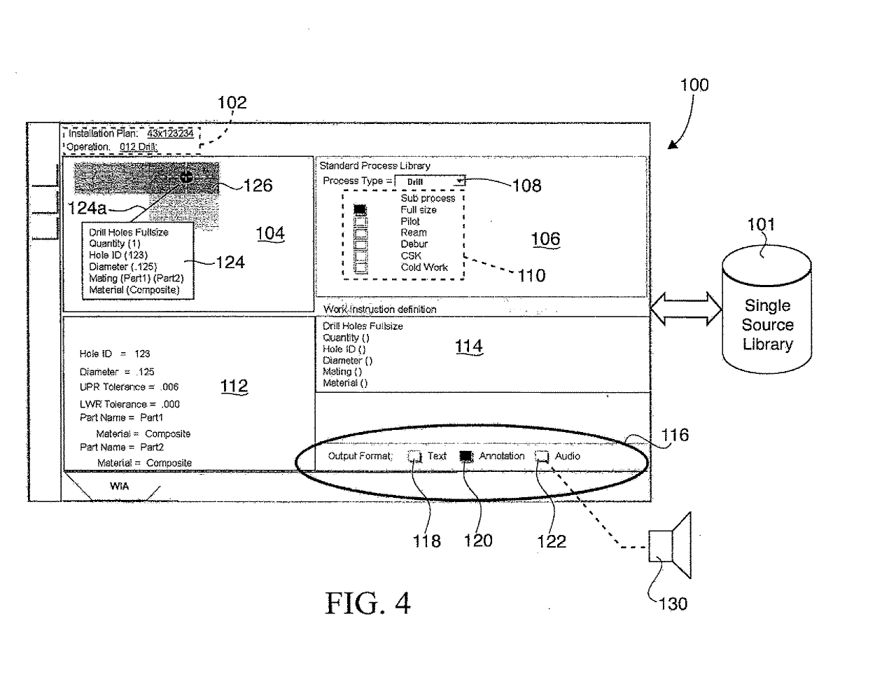

When a fabrication, assembly or installation plan is required on the shop floor, a process is triggered to create a “shop order Instance” 29a using a shop floor worker station 29. This shop order Instance 29a contains all part, process and tool data required to perform a process. This data is presented to the shop floor worker as defined in the manufacturing application 26. (Note FIGS. 4 & 5 for notional depiction of the shop floor viewing interface and work instruction formatting options.)

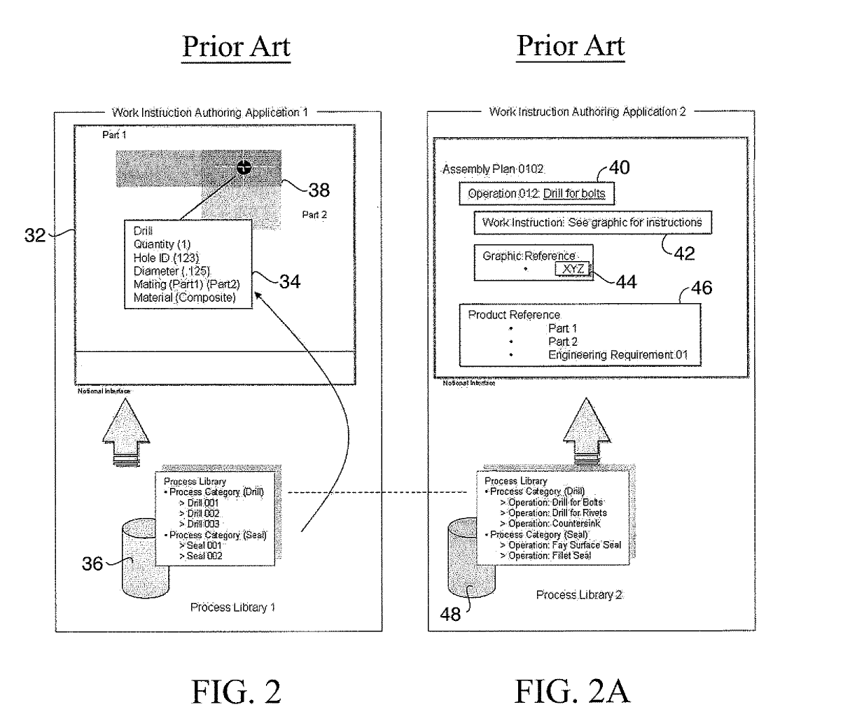

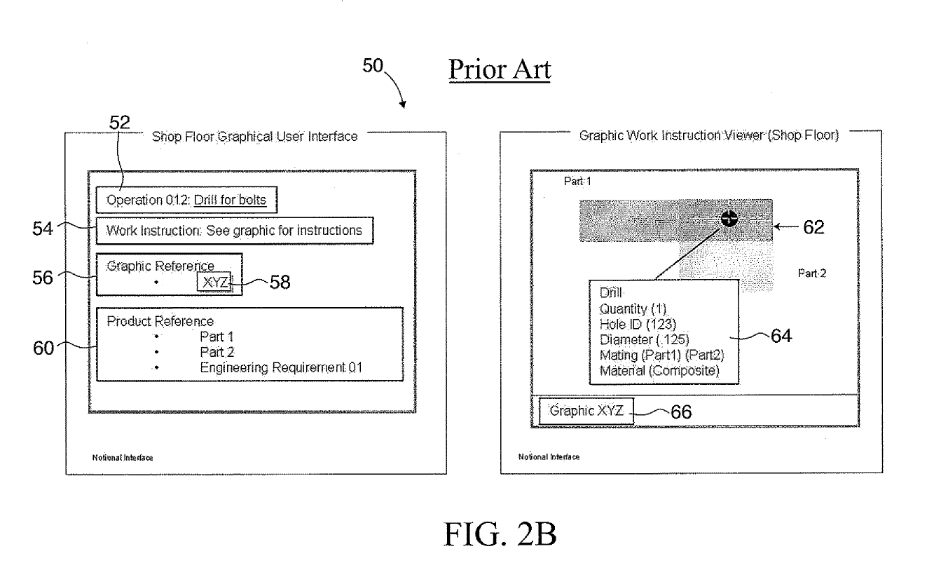

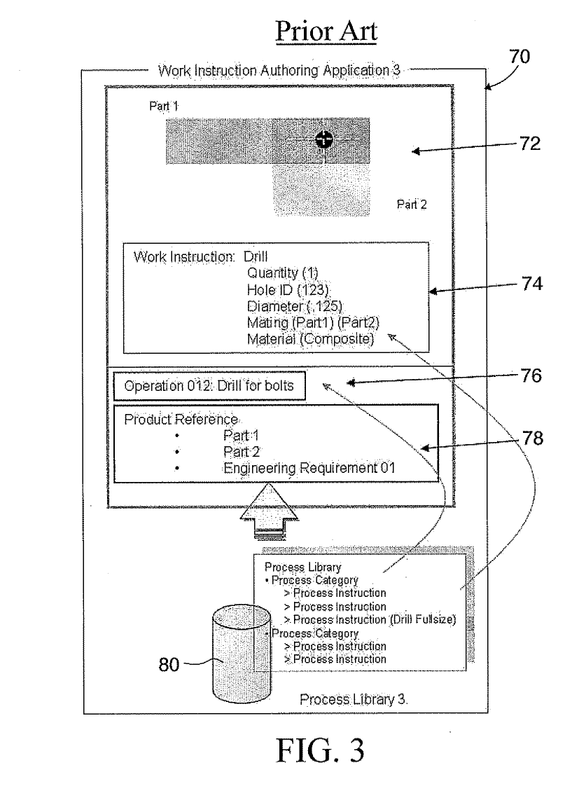

Referring now to FIGS. 2 and 2A, prior art systems require elements of a graphic based work instruction to be created in multiple applications. Two dimensional plan information is created in one system, with the graphic or model based content being produced in another application. Typically the plan author uses a text based authoring application to create the plan structure, operations, part associations and then makes a reference to a graphic(s) that contains additional work instruction content. The graphic is created in an authoring application more suitable for producing graphics such as a CAD application and the graphic is subsequently stored in a Product Data Manager (PDM) application. The graphic identifier is then referenced in the text based authoring application and the shop floor graphical user interface allows, via a link, for a graphical viewer to be launched and the graphic to be accessed from the PDM and displayed.

The disadvantage to using multiple applications to create a combined output is that the data that makes up the plan content in the two applications has to be carefully maintained to insure that data integrity is insured. This adds cost and increases opportunity for quality issues.

The output from both applications is combined in the display of the work instruction, typically by the two dimensional plan referencing the graphic based content (to be discussed further in connection with FIG. 2B). In this example, FIG. 2 shows work instruction authoring application 1 having a field 32 that provides a 2D or 3D graphical illustration relating to a work instruction. Included is an annotation 34 that presents specific text information relating to the work instruction. Information is obtained for the work instruction from a standard (i.e., first) process library 36. FIG. 2A shows a second work instruction authoring application (i.e., application 2) needed to create the data. The application of FIG. 2A includes a field for an operation title 40, a field 42 for a work instruction text window, a field 44 for a graphic reference that specifies a graphic identifier, and a field 46 for a product reference. The field 46 provides a list of the parts associated to the operation. A separate process library 48 is used to obtain the needed information to produce the component of the work instruction being created by application 2 of FIG. 2A.

FIG. 2B illustrates a prior art shop floor graphical user interface 50. This interface 50 commonly uses a single application for navigating through the plan with an integrated viewer application, for the graphical or model based content of the plan. A field 52 provides an operation number and title; field 54 provides work instruction text; field 56 provides a graphic reference and graphic identifier; field 58 displays a graphic link that allows the graphic identifier to be selected and the graphic viewer to launch and display the graphic; field 60 displays a product reference which lists parts associated to the operation. The work instruction viewer portion of the interface 50 includes a graphic reference 62 that specifies a graphic identifier; an annotated work instruction text field 64 integrated with a 2D or 3D view; and a graphic identifier 66.

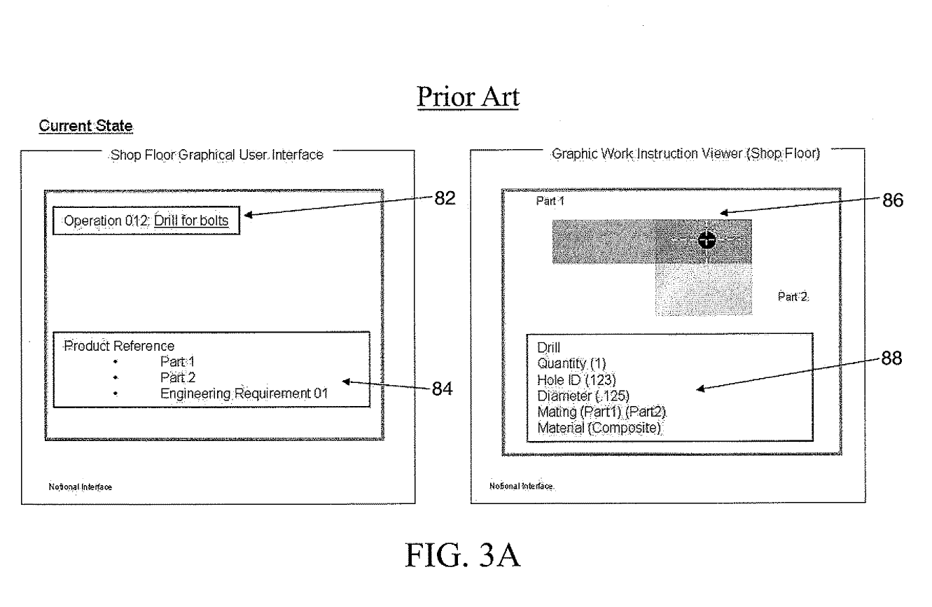

FIG. 3 illustrates a somewhat similar, prior art work authoring application 70 that provides a 2D or 3D graphic model 72, a field 74 for a work instruction text window; a field 76 for operation, identification and/or title; a field 78 for a product reference to list the parts associated to the operation; and a standard process library 80 that provides standard operation text and work instruction text. The system of FIG. 3 allows both the textual content of the plan and the graphical content to be created in a single system, but still does not have the ability to display the work instructions (from a process library) in an annotated format.

FIG. 3A illustrates another prior art shop floor graphical user interface similar to that shown in FIG. 2B, that might be used with the system of FIG. 3. Field 82 provides an operation and title; field 84 provides a product reference that lists the parts associated to the operation; field 86 provides a 2D or 3D graphic view and field 88 provides a work instruction text window.

From the prior art systems of FIGS. 2, 2A, 2B, 3 and 3A, it will be appreciated that the user does not have the ability to select the optimum output format for information when using a given work instruction authoring tool. Moreover, the user is required to use multiple work authoring tools to create different components of a work instruction. This significantly adds to the overall system complexity and cost.

Referring now to FIGS. 4-6, a software module 100 is illustrated in accordance with one exemplary embodiment of the present disclosure. Referring specifically to FIG. 4, the software module 100 may be in bidirectional communication with a single source library 101 containing a variety of information and data pertaining to a large plurality of different work instructions. Such work instructions may be required for a design, manufacturing, or other form of work instruction authoring task that is being managed by the user operating the software module 100.

The software module 100 may include a first field 102 in which a user specifies at least one of a plurality of criterion to be used in implementing a work instruction via a previously selected work instruction authoring tool. In this example, field 102 enables a specific “Installation Plan” to be input, as well as a specific “Operation”. The installation plan may be selected from a list of plans and opened from the manufacturing database 24 (FIG. 1) and the ID displayed in field 102. Similarly, the operation ID and process title could already exist (i.e., could have been previously created), but also could be created in this field. A second field 104 may be used to present a graphic illustration of the work instruction elements or components that are used in connection with the work instruction. A third field 106 may be used to enable selection via a drop down menu 108 of a specific process type to be performed via the work instruction authoring tool. While a “drill” is shown as having been the process type selected, other process types might include, without limitation, “locate”, “debur”, “attach”, “clean”, “seal”, “paint”, “cut”, “form”, “bend”, “punch”, “assemble”, etc. Selecting a specific process type from the drop down menu 108 enables the plurality of sub-process selections 110 to be selected by the user that relate to the specific process type selected via the drop down menu 108. Field 112 is used to display specific product data associated with the work instruction selected via the drop down menu 108 and the sub-process selection 110. Field 114 forms a work instruction definition field that the software module 100 populates with information, depending on the sub-process 110 selected by the user. The pertinent information is presented within each of the parentheses in field 114 after each of the listed parameters “Quantity”, “Hole ID”, “Diameter”, “Mating” and “Material”. Obviously, these parameters will depend on the specific Process Type and Sub process selected from menu 108 and sub-process selections 110.

Field 116 provides the user selectable output format that significantly enhances the utility and convenience of using a work authoring tool on the software module 100. Field 116 allows the user to select either a text output via selection box 118, an annotation output via selection box 120 or an audio output via selection box 122. In this example, the annotation box 120 has been selected. This provides annotation window 124 adjacent a graphic 126 with a lead line 124a connecting the annotation window 124 and the graphic 126. Thus, the graphic 126 graphically illustrates various components or elements of the work instruction to be carried out while the annotation window 124 presents a convenient display of annotated text information pertinent to the particular work instruction being performed. It will be appreciated that the amount of information provided in the annotation window 124 may vary significantly as needed to best suit the needs of the particular work instruction. The annotation window 124, in this example, provides six distinct pieces of information relating to a “Drill” work instruction that enables the user to quickly and easily identify several of the more important parameters for this work instruction.

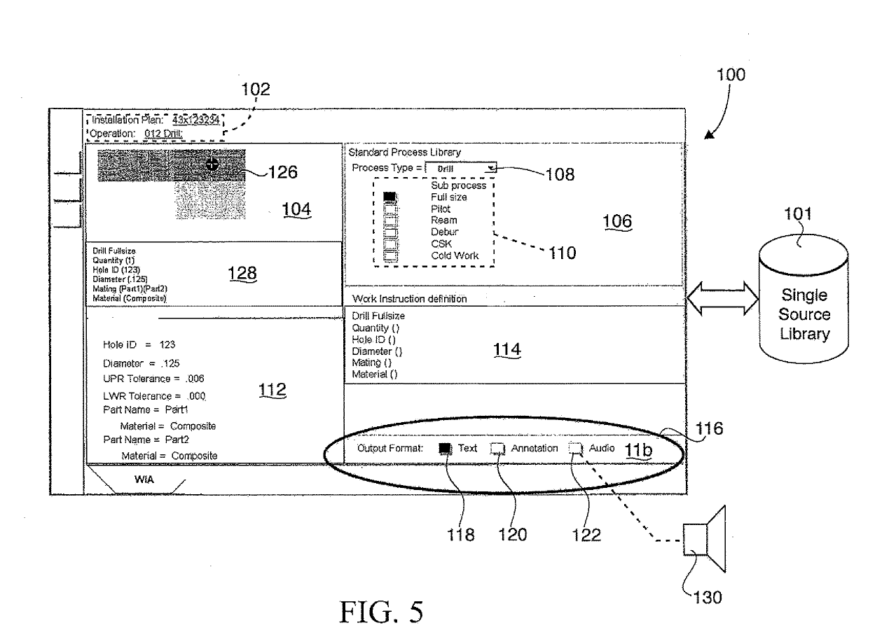

Referring to FIG. 5, the software module 100 is shown with the text selection 118 being selected. When the text selection 118 is selected the text window 128 is created. In this example, the text window 128 is presented adjacent to the display field 104, although it need not be directly adjacent to the display field 104. The text window 128 provides a detailed listing of information relating to a number of parameters that are pertinent to the work instruction selected from the process type drop down menu 108 and the sub-process selection options 110. In practice, the amount of information provided in the text field 128 will typically be considerably larger than that presented in the annotation window 124 of FIG. 4, although it need not be.

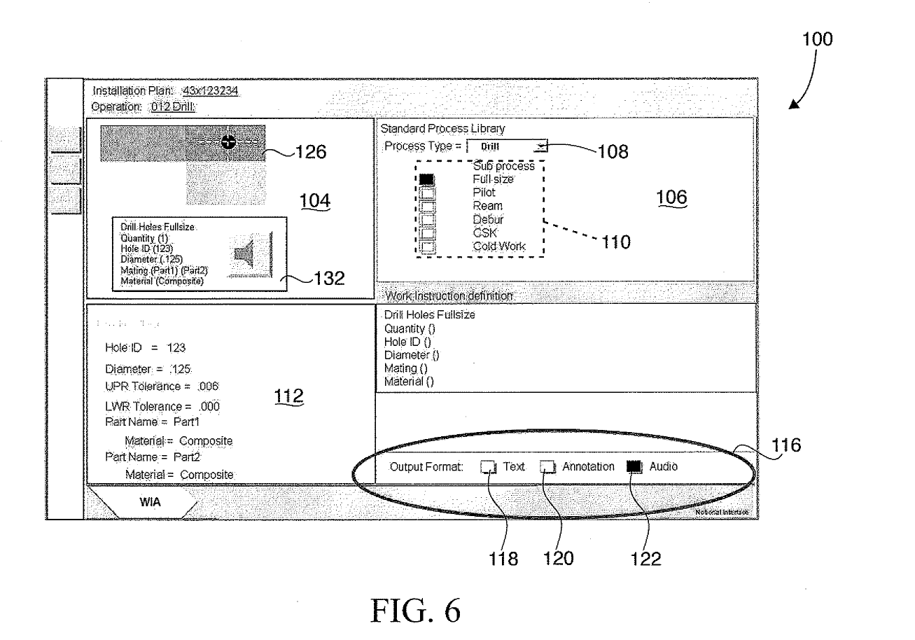

If the audio selection 122 of the software module is selected, an audio output via a suitable audio device 130 is provided to the user. FIG. 6 illustrates the audio output 122 having been selected, which provides a notational audio work instruction format 132. Audio is beneficial for situations where the shop worker cannot bring conventional work instructions into the work zone. One such example is a work zone where physical space and movement is confined or limited. Another example where an audio output is beneficial is for situations where a worker cannot safely look away from the process they are performing to read a single or multi-step instruction. Audio provides a step-by-step presentation of the instructions without the need to physically read the instructions.

With further reference to FIGS. 4 and 5, it will be appreciated that the work instruction definition field 114 may be used to depict a “generative” instruction methodology or “standard process instruction”. A generative instruction may be viewed as a general instruction that is formatted to allow engineering values from the product being worked on by the work instruction to be imported into the instruction. Conversely, a “standard instruction” may be viewed as a standard process defined in a process library (for example, the single source library 101), that when applied to the work instruction is not modifiable.

The system and method of the present disclosure enables a single work construction authoring application to be used with a single source library of process data. The system and method also enables a plurality of different types of output formats to be used to display information pertaining to specific work instructions. Thus, the system and method allows significantly added output flexibility that assists the user in most effectively and efficiently using a work authoring application. The user is provided with the ability to select a standard processing instruction from the single source library 101 that is associated with a work instruction, and then to select how information pertaining to the selected work instruction is to be displayed.

The system and method of the present disclosure provides a number of advantages over previously developed work instruction authoring applications. The system and method of the present disclosure supports common processes and tools, can reduce software licensing costs, can reduce information technology (IT) support costs, can reduce the training costs for users in learning to use different work instruction authoring tools, and can leverage the use of a single standard process library for use in the creation of a wide variety of work instructions. The system and method can further enable multi-format work instructions to be created from a single process database (e.g., single source library 101).

While various embodiments have been described, those skilled in the art will recognize modifications or variations which might be made without departing from the present disclosure. The examples illustrate the various embodiments and are not intended to limit the present disclosure. Therefore, the description and claims should be interpreted liberally with only such limitation as is necessary in view of the pertinent prior art.

What is claimed is:

1. A method for enabling work instruction authoring from a single source library, comprising:
using a software module to enable a user to access a selected one of a plurality of different work instruction authoring tools provided by the software module, each of the work instruction authoring tools being able to access the single source library to obtain information therefrom;
using the software module to provide an output selection field from which the user may select one of a plurality of different output formats in which information generated by the selected work instruction authoring tool may be presented to the user; and
using the software module to present information resulting from the selected work authoring tool to the user in accordance with a selected one of said output formats.

2. The method of claim 1, wherein selecting one of a plurality of different output formats comprises selecting an audio output format.

3. The method of claim 1, wherein said selecting one of a plurality of different output formats comprises selecting an output for displaying an annotation that includes text that pertains to information associated with a work operation.

4. The method of claim 1, wherein selecting one of said plurality of different output formats comprises selecting a text window output that contains text pertaining to the information generated by the selected work instruction authoring tool.

5. The method of claim 1, further comprising using a selection field accessible through said software module for enabling a user to select at least one of a fabrication plan, an assembly plan or an installation plan.

6. The method of claim 1, further comprising using said software module to provide a visual display field for displaying a visual representation of information obtained from the single source library.

7. The method of claim 1, further comprising using said software module to display a menu, said menu including a plurality of predetermined, different process types that said user may select.

8. The method of claim 7, further comprising using said software module to display a preview of text information pertaining to a selected one of said process types.

9. A method for enabling work instruction authoring from a single source library, comprising:
using the single source library to serve a plurality of different work instruction authoring applications;
using a software module to provide an input selection by which a user may select one of a plurality of different work tasks to be performed from a selected one of a plurality of work instruction authoring tools, in which the selected work instruction authoring tool accesses the single source library to obtain information therefrom;
using the software module to select one of a plurality of different process types pertaining to the selected work instruction authoring tool;
using the software module to provide an output selection field from which the user may select one of a plurality of different output formats in which information generated by the selected work instruction authoring tool may be presented to the user in;
using the software module to generate a visual characterization of information pertaining to said selected process type; and
using the software module to present information resulting from the selected work authoring tool to the user in accordance with a selected one of said output formats.

10. The method of claim 9, wherein said selecting one of a plurality of different output formats comprises selecting an output for displaying a text annotation of information associated with the user selected process type.

11. The method of claim 9, wherein selecting one of said plurality of different output formats comprises selecting a text window that contains text pertaining to the selected process type.

12. The method of claim 9, wherein selecting one of said plurality of different output formats comprises selecting an audio output of information pertaining to the selected process type.

13. The method of claim 9, wherein using the software module to generate a visual characterization of information comprises using the software module to generate a two dimensional or three dimensional characterization of information pertaining to the selected process type.

14. The method of claim 9, further comprising enabling said user to select one of a plurality of sub process type operations after selecting a specific said process type.

15. The method of claim 9, further comprising using the software module to generate text within a product data field that relates to product data associated with the user selected process type.

16. The method of claim 9, further comprising using said software module to provide a work instruction definition field in which said user can input specific information parameters pertaining to a work operation to be carried out by the software module.

17. A software product comprising:
a first field in which a user may specify at least one of a plurality of criteria to be used in implementing a work instruction via a work instruction authoring tool;
a second field in which a user may select one of a plurality of different work process types to be performed during the selected work instruction;
a third field in which the user may select one of a plurality of different output formats to be used in providing information to the user concerning the selected work instruction; and
a fourth field in which specific information concerning the selected work instruction is provided to the user in accordance with the selected output format.

18. The software product of claim 17, wherein one of the different output formats comprises an audio output.

19. The software product of claim 17, wherein one of the different output formats comprises a text annotation of information associated with said selected work instruction.

20. The software product of claim 17, wherein one of said different output formats comprises text relating to information associated with said selected work instruction that is displayed in an independent text field.
